(19) United States
(12) Patent Application Publication
(10) Pub. No.: US 2006/0005920 A1
(43) Pub. Date: Jan. 12, 2006

(54) Method for fabricating bonded substrate

(75) Inventors: Takanori Muramoto, Kasugai (JP); Takuya Ohno, Kasugai (JP); Kazushige Komatsu, Kasugai (JP); Koji Hashizume, Kasugai (JP); Tsukasa Adachi, Kasugai (JP); Yoshimasa Miyajima, Kasugai (JP); Katsuhiro Nakashima, Kasugai (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/224,134

(22) Filed: Sep. 13, 2005

Related U.S. Application Data
(62) Division of application No. 10/453,654, filed on Jun. 4, 2003.

(30) Foreign Application Priority Data
Jun. 11, 2002 (JP) 2002-170007
Mar. 5, 2003 (JP) 2003-059075

(51) Int. Cl. B29C 65/00

(52) U.S. Cl. 156/285

(57) ABSTRACT

A method of fabricating bonded substrates with fewer production defects. The method includes forming a frame of a seal on a surface of a first substrate; disposing first and second substrates into a process chamber, depressurizing the process chamber; moving at least one of the first and second substrates in such a way that the first and second substrates approach each other, computing a pressing load acting on the first and second substrates; stopping movement of the at least one of the first and second substrates when the computed pressing load reaches a target load; and setting a pressure in the process chamber back to atmospheric pressure.

### CROSS-REFERENCE TO RELATED APPLICATIONS

This application is a divisional of application Ser. No. 10/453,654, filed Jun. 4, 2003, now pending.

This application is based upon and claims the benefit of priority from the prior Japanese Patent Applications No. 2002-170007 filed on Jun. 11, 2002 and No. 2003-059075 filed on Mar. 5, 2003, and U.S. patent application Ser. No. 10/453,654, filed Jun. 4, 2003, the contents being incorporated herein by reference.

### BACKGROUND OF THE INVENTION

The present invention relates to a method and an apparatus for fabricating a bonded substrate, and, more particularly, to a method and an apparatus for fabricating a panel, such as a liquid crystal display (LCD), which is provided by bonding two substrates at a predetermined gap therebetween.

Recently, there are demands for apparatuses which manufacture large and thin flat display panels, such as liquid crystal display (LCD) panels with a high productivity and at a low cost. An LCD panel is fabricated by arranging two glass substrates to face each other at an extremely narrow gap (several micrometers) and filling a liquid crystal between the two glass substrates. The two glass substrates are, for example, an array substrate on which a plurality of TFTs (Thin Film Transistors) are formed in a matrix form and a color filter substrate on which color filters (red, green and blue) and a light shielding film are formed. The light shielding film contributes to improving contrast and shields light toward the TFTs to prevent generation of an optical leak current. The array substrate is bonded to the color filter substrate by a seal (adhesive) containing a thermosetting resin.

A conventional method of fabricating an LCD panel includes a liquid crystal sealing step of sealing a liquid crystal between two glass substrates. The conventional liquid crystal sealing step is carried out by the following vacuum injection method. First, the TFTs-formed array substrate is bonded to the color filter substrate (opposing substrate) via a seal. The seal is cured. An inlet port is formed in the seal. The bonded substrates and a liquid crystal are placed in a vacuum tank. While the inlet port is immersed in the liquid crystal, the pressure in the tank is set back to atmospheric pressure. This causes the liquid crystal to be sucked from the inlet port. Finally, the inlet port of the seal is sealed.

Recently, attention has been paid to the following dropping method instead of the vacuum injection method. First, the frame of a seal is formed in such a way as to enclose the outer periphery of the array substrate. A predetermined dose of a liquid crystal is dropped on the surface of the array substrate within the frame of the seal. Finally, the array substrate is bonded to the color filter substrate in vacuum. The dropping method can reduce the amount of a liquid crystal in use significantly and can shorten the time needed for the liquid crystal sealing step, thus resulting in a reduction in panel fabrication cost. It is therefore expected that mass production will be improved.

However, a bonded substrate fabricating apparatus which operate according to the dropping method has the following problems.

1. Improper Bonding

An LCD panel is manufactured by bonding two substrates at a predetermined gap (cell gap) therebetween. To set the cell gap to a predetermined value, such as about 5 micrometers, the two substrates should be held in parallel to each other accurately.

There is a case where the bonded substrates are deformed in the process of bonding the two substrates together in a vacuum process chamber in vacuum, setting the pressure in the vacuum process chamber back to atmospheric pressure and curing the seal. This is caused because the force of pressing the substrates in the direction to bond them together does not work outside the seal where atmospheric pressure works, whereas the force of bonding the substrates together works inside the seal where the liquid crystal is sealed. As the substrates are deformed, the cell gap becomes uneven, resulting in improper bonding.

As a solution to this shortcoming, Japanese Laid-open Patent Publication No. Hei 11-326922 discloses an outer seal so provided outside the seal as to surround that seal. Keeping the space between the inner seal and the outer seal in vacuum allows the cell gap to be stable even after both seals are cured.

The factors for making the cell gap uneven are the deformation of the substrates and variations in the thicknesses of the substrates and the seal. Due to the variations in the thicknesses of the substrates and the seal, in a case where the substrates are bonded without being held in parallel to each other, the outer seal cannot keep the space between the substrates at a high airtightness. This also leads to improper bonding.

2. Influence on Substrates When Bonded

The two substrates are bonded in a vacuum process chamber while being respectively held by two holding plates that have a vacuum chuck mechanism or an electrostatic chuck mechanism. In vacuum chuck, the bottom surfaces of the substrates are sucked by the chuck surfaces of the holding plates coupled to a vacuum pump. In electrostatic chuck, a voltage is applied between an electrode formed on each holding plate and a conductive film formed on the associated substrate, generating force according to Coulomb's law between the glass of the substrate and the electrode, which allows the substrate to be chucked on the holding plate. Because the vacuum chuck does not work as the degree of vacuum in the vacuum process chamber becomes high, the substrates are held by electrostatic chuck, not vacuum chuck, under a high vacuum state.

Substrates are bonded as follows. The two substrates are held by two holding plates facing each other. A seal is provided on one substrate. The pressure in the vacuum process chamber is reduced. Both holding plates are placed close to each other until the cell gap reaches a predetermined value, thus causing both substrates to firmly contact the seal.

If the substrates are not kept in parallel to each other, the substrates may be damaged. Specifically, spacers (spherical spacers, columnar spacers or the like) are provided on one substrate to adjust the cell gap to a predetermined value, so that if both substrates are bonded not in parallel to each other, high pressure is locally applied to the substrates, thus damaging the substrates.

3. Deformation of Vacuum Process Chamber and Reduction in Substrate Position Precision

As the pressure in the vacuum process chamber is reduced, the difference between the inner pressure of the vacuum process chamber and the outer pressure (atmospheric pressure) slightly deforms the vacuum process chamber. Therefore, the relative positions of both holding plates slightly differ between when the pressure in the vacuum process chamber is reduced and when the pressure in the vacuum process chamber is not reduced. The positional deviation of the holding plates lowers the accuracy of the bonding position of the substrates. If the outer wall of the vacuum process chamber is made thicker to suppress the deformation of the vacuum process chamber, the vacuum process chamber becomes larger which is not desirable.

### SUMMARY OF THE INVENTION

In one aspect of the present invention, a bonded substrate fabricating apparatus for bonding a first substrate and a second substrate together is provided. The apparatus includes a depressurizable process chamber. A first holding plate is disposed in the process chamber for holding the first substrate, and a second holding plate is disposed facing the first holding plate in the process chamber for holding the second substrate. A pressing mechanism drives the first holding plate to press the first and second substrates. The second holding plate is slid and rotated within a horizontal plane by a drive mechanism. Resilient members are disposed between the process chamber and the pressing mechanism and between the process chamber and the drive mechanism.

In a further aspect of the present invention, a method of fabricating a bonded substrate from first and second substrates includes the steps of forming a frame of a seal on a surface of the first substrate, disposing the first and second substrates into a process chamber, depressurizing the process chamber, moving at least one of the first and second substrates in such a way that the first and second substrates approach each other, computing a pressing load acting on the first and second substrates, stopping movement of the at least one of the first and second substrates when the computed pressing load reaches a target load, and setting a pressure in the process chamber back to atmospheric pressure.

Other aspects and advantages of the present invention will become apparent from the following description, taken in conjunction with the accompanying drawings, illustrating by way of example the principles of the invention.

### BRIEF DESCRIPTION OF THE DRAWINGS

The features of the present invention that are believed to be novel are set forth with particularity in the appended claims. The invention, together with objects and advantages thereof, may best be understood by reference to the following description of the presently preferred embodiments together with the accompanying drawings in which:

FIG. 1 is a block diagram of a substrate bonding apparatus according to a first embodiment of the present invention;

FIG. 2 is a schematic front view of a press machine;

FIG. 3 is a block diagram of a press control unit;

FIG. 4 shows an example of connection between the press control unit and load cells;

FIGS. 5 and 6 show examples of the layout of the load cells;

FIG. 7 is a diagram for explaining the position of a CCD camera;

FIG. 8 is a plan view of a substrate to which a seal and a liquid crystal are applied;

FIGS. 9A and 9B are cross-sectional views of substrates in a process of being bonded;

FIGS. 10A and 10B are respectively a plan view and a cross-sectional view of one substrate to which an outer seal is applied;

FIGS. 11A and 11B are respectively a plan view and a cross-sectional view showing another example of one substrate to which an outer seal is applied;

FIG. 12 is an enlarged view of an outer seal applied to a corner of a substrate;

FIG. 13 is a graph showing the gap between substrates and the pressing load;

FIGS. 14 and 15 are flowcharts for a substrate bonding method; and

FIG. 16 shows a schematic front view of a press machine according to a second embodiment of the present invention;

FIGS. 17A and 17B are respectively a bottom view and a side view showing a pressure plate of the press machine of FIG. 16;

FIGS. 18A, 18B and 18C are cross-sectional views of a pressure plate and a table performing bonding of substrates; and

FIG. 19 shows a modification of the press machine.

### DETAILED DESCRIPTION OF THE PREFERRED EMBODIMENTS

A bonded substrate fabricating apparatus 11 according to a first embodiment of the present invention will be described below.

The bonded substrate fabricating apparatus 11 fabricates a liquid crystal display by placing liquid crystal between a first substrate W1 and a second substrate W2 and then bonding the substrates W1 and W2. The liquid crystal display is, for example, an active matrix type liquid crystal display panel. The first substrate W1 is an array substrate (TFT substrate) of glass which has an array of TFTs. The second substrate W2 is a color filter (CF) substrate which has color filters and a light shielding film. The substrates W1 and W2 are fabricated separately and are supplied to the bonded substrate fabricating apparatus 11.

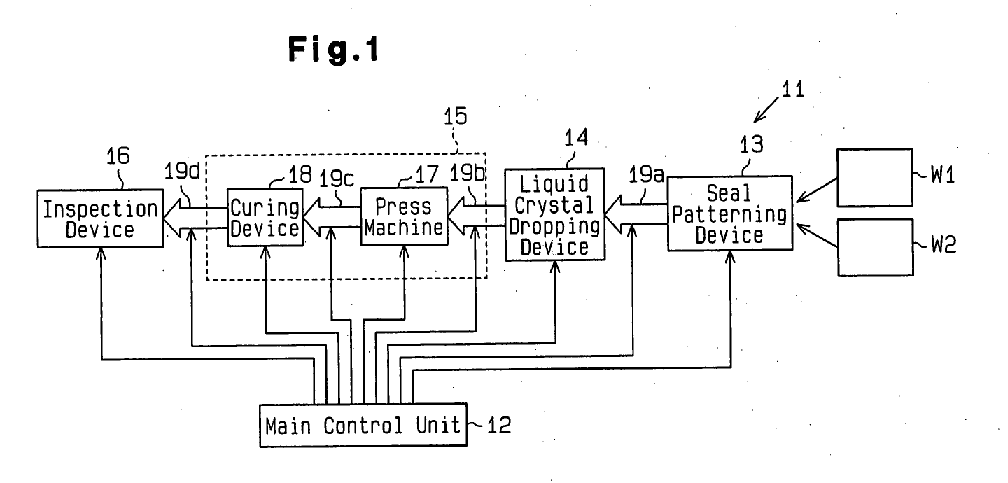

As shown in FIG. 1, the bonded substrate fabricating apparatus 11 includes a main control unit 12, a seal patterning system 13, a liquid crystal dropping device 14, a bonding device 15 and an inspection device 16. The bonding device 15 includes a press machine 17 and a curing device 18. The main control unit 12 controls the seal patterning system 13, the liquid crystal dropping device 14, the bonding device 15 (the press machine 17 and curing device 18) and the inspection device 16.

The bonded substrate fabricating apparatus 11 includes a first transfer equipment 19a, a second transfer equipment 19b, a third transfer equipment 19c, and a fourth transfer equipment 19d, which transfer the first substrate W1 and second substrate W2. The main control unit 12 controls the transfer equipments 19a to 19d to transfer the first substrate W1 and second substrate W2 and a bonded substrate.

The seal patterning system 13 applies a seal at predetermined locations on the top surface of one of the substrates W1 and W2 (the first substrate W1 (array substrate) in the first embodiment) along the periphery, thereby forming the frame of the seal. The seal includes preferably an adhesive, such as a photo-curing adhesive. The first transfer equipment 19a transfers the substrates W1 and W2 as a set to the liquid dropping device 14 from the seal patterning system 13.

The liquid dropping device 14 drops liquid crystal at plural predetermined locations in the frame of the seal on the top surface of the first substrate W1. After the dropping, the substrates W1 and W2 are transferred to the press machine 17 by the second transfer equipment 19b.

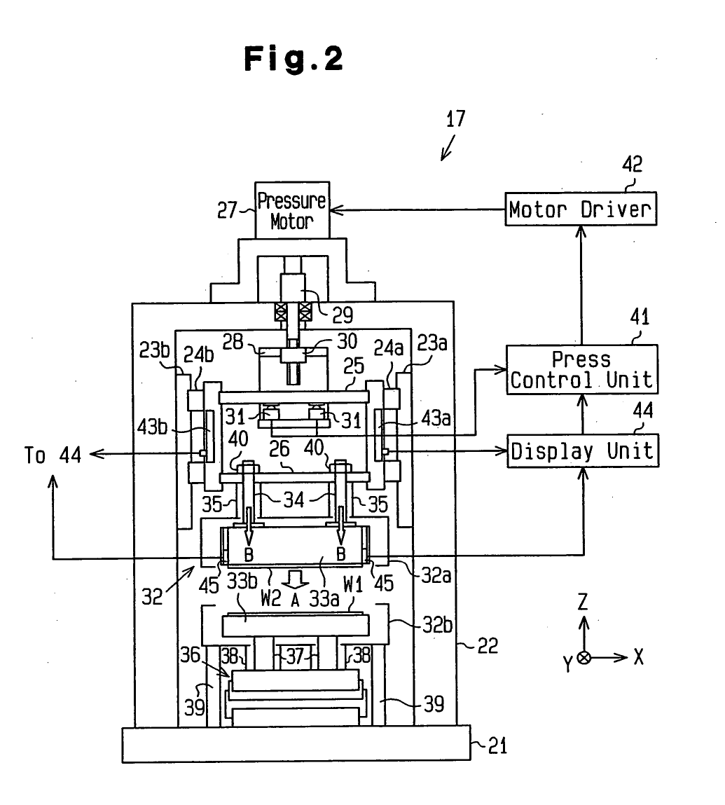

The press machine 17 has a vacuum process chamber 32 (FIG. 2). The substrates W1 and W2 are chucked and held by a lower chuck and an upper chuck, respectively. The press machine 17 evacuates the vacuum process chamber 32 and feeds a preprocess gas to the vacuum process chamber 32. The preprocess gas is a substitutional gas including a reactive gas, such as an exciting gas for a plasma display panel (PDP), a nitrogen gas, an inactive gas, or dean dry air. In the preprocess, impurities and products which are adhered to the surfaces of the substrates W1 and W2 or the surfaces of display elements are exposed to the preprocess gas for a given time. The preprocess stably maintains the property of the bonded surfaces which cannot be unsealed after bonding. In general, an oxide layer is formed on the surfaces of the substrates W1 and W2 and airborne materials in the air are adhered to the surfaces. This may change the states of the surfaces of the substrates W1 and W2. As the degree of a change in the surface state varies between the substrates W1 and W2, the qualities of the panels differ from one panel to another. In this respect, changes in the surfaces of the substrates W1 and W2 are suppressed by performing the preprocess which suppresses the formation of an oxide layer and the adhesion of impurities and processes the adhered impurities.

While optically detecting an alignment mark, the press machine 17 aligns the first substrate W1 with the second substrate W2 in such a way that the seal and liquid crystal on the first substrate W1 do not contact the bottom surface of the second substrate W2. The press machine 17 presses the substrates W1 and W2 with a predetermined load. After pressing, the press machine 17 releases the vacuum process chamber 32 to set the pressure in the vacuum process chamber 32 to atmospheric pressure. The difference between atmospheric pressure and the pressure in the space between the substrates W1 and W2 compresses both substrates W1 and W2 to a predetermined cell gap.

While monitoring the time passed from the point when the substrates W1 and W2 were transferred to the vacuum process chamber 32, the main control unit 12 controls the elapsed time from the point of transfer to the point of bonding in such a way that the substrates W1 and W2 are exposed to the gas supplied to the vacuum process chamber 32 over a predetermined time. This stabilizes the bonded surfaces of the substrates W1 and W2 and allows the bonded surfaces to have a predetermined property.

The third transfer equipment 19c removes the bonded substrates W1 and W2 (liquid crystal panel) from the press machine 17 and transfers it to the curing device 18. When the time elapsed from the point at which the liquid crystal panel was pressed reaches a given time, the main control unit 12 drives the third transfer equipment 19c to supply the liquid crystal panel to the curing device 18.

The liquid crystal that has been sealed in the LCD panel spreads between the substrates W1 and W2 due to the load from being pressed and atmospheric pressure.

It is necessary to cure the seal before the liquid crystal reaches the frame of the seal. Therefore, the curing device 18 irradiates light having a predetermined wavelength on the LCD panel to cure the seal after a predetermined time passes after pressing. The predetermined time is acquired beforehand through experiments from the spreading time of the liquid crystal and the time needed to release the press stress remaining on the substrates W1 and W2.

The press stress remains on the bonded substrates W1 and W2. Because the seal is not cured while the substrates W1 and W2 are transferred to the curing device 18, the press stress is released from the substrates W1 and W2. The stress hardly remains on the substrates W1 and W2 when the seal is cured. This reduces the occurrence of positional deviation of the bonded substrates W1 and W2 after the seal is cured.

After the seal is cured, the fourth transfer equipment 19d transfers the bonded substrates W1 and W2 (LCD panel) from the curing device 18 to the inspection device 16. The inspection device 16 inspects for positional deviation of the first substrate W1 and the second substrate W2 and supplies the inspection result to the main control unit 12. Based on the inspection result, the main control unit 12 calibrates the alignment of substrates to be pressed next. That is, the positional deviation of an LCD panel to be manufactured thereafter is prevented by shifting beforehand both substrates W1 and W2 of the cured-seal in the LCD panel in a direction opposite to the direction of the positional deviation by the amount of the deviation.

The press machine 17 which presses the substrates W1 and W2 will be discussed below.

As shown in FIG. 2, the press machine 17 includes a rigid base plate 21 and a rigid gate 22 fixed to the base plate 21. The base plate 21 and the gate 22 are formed of materials having a high rigidity. Attached to the two supports of the gate 22 are guide rails 23a and 23b which guide the movements of linear guides 24a and 24b. First and second support plates 25 and 26 are put between the linear guides 24a and 24b. The first support plate 25 is suspended from a support arm 28 which is moved up and down by a pressure motor 27 attached to the upper portion of the gate 22.

A ball screw 29 is coupled to the output shaft of the pressure motor 27 in such a way as to be rotatable together. A nut 30 provided on the support arm 28 is threaded onto the ball screw 29. The support arm 28 moves up or down in accordance with the rotational direction (forward or reverse) of the output shaft of the pressure motor 27.

The support arm 28 is formed by a top plate 28a, a bottom plate 28b parallel to the top plate 28a and a coupling plate 28c which couples the top plate 28a to the bottom plate 28b. A plurality of load cells 31 are mounted on the bottom plate 28b and abut on the bottom surface of the first support plate 25.

The vacuum process chamber 32 is defined by an upper container 32a and a lower container 32b which are separable. A first holding plate or a pressure plate 33a is provided in the upper container 32a. A second holding plate or a table 33b is provided in the lower container 32b. The pressure plate 33a faces the upper surface of the table 33b. The pressure plate 33a holds the second substrate W2 (CF substrate) and the table 33b holds the first substrate W1 (TFT substrate).

The pressure plate 33a is suspended from the second support plate 26 via four suspension rods 34. Specifically, the second support plate 26 has plural through holes (e.g., four in the first embodiment) where the respective suspension rods 34 are inserted. The upper end of each suspension rod 34 is widened so that the suspension rod 34 does not come off. The pressure plate 33a is coupled to the lower ends of the suspension rods 34.

Each suspension rod 34 is covered with an upper bellows 35 as a resilient member. The upper bellows 35 has flange portions at both ends. Both flange portions are coupled to the second support plate 26 and the upper container 32a via O-rings as sealing members. The upper bellows 35 is connected in an airtight manner to the vacuum process chamber 32. The upper container 32a is suspended from the second support plate 26 by the upper bellows 35.

The table 33b is secured to a positioning stage 36 via plural (four) legs 37. The positioning stage 36 is fixed to the base plate 21. The positioning stage 36 has a slide mechanism which moves the table 33b horizontally and a rotary mechanism which rotates the table 33b within a horizontal plane.

The positioning stage 36 is connected to the lower container 32b via plural (four) lower bellows 38. The lower bellows 38 surround the respective legs 37 and are communicated in an airtight manner with the vacuum process chamber 32. Each lower bellows 38 has flange portions at both ends. Both flange portions are coupled to the positioning stage 36 and the lower container 32b via O-rings as sealing members. A plurality of support rods 39 fixed to the base plate 21 are attached to the bottom of the lower container 32b. Therefore, the lower container 32b is supported on the positioning stage 36 via the lower bellows 38 and is also supported on the base plate 21 via the support rods 39.

A level adjuster 40 is provided between the upper end of each suspension rod 34 and the second support plate 26. The level adjuster 40 includes, for example, a screw and a nut formed on the associated suspension rod 34, and moves the suspension rod 34 up or down as it is turned. The level adjuster 40 adjusts the pressure plate 33a horizontally. It is preferable that the pressure plate 33a relative to the table 33b be adjusted to 50 micrometers or less deviation from parallel to one another.

As the pressure motor 27 is driven, the support arm 28, the first support plate 25 and the linear guides 24a and 24b move up or down along the guide rails 23a and 23b and the second support plate 26, the upper bellows 35 and the upper container 32a move up or down. Therefore, the pressure motor 27 moves the upper container 32a closer to or away from the lower container 32b. When the upper container 32a comes in contact with the lower container 32b, the vacuum process chamber 32 is closed. As the pressure motor 27 is driven further, the pressure plate 33a alone moves downward via the second support plate 26 and the suspension rods 34. The upper bellows 35 are compressed, causing the substrates W2 and W1 to be pressed by the pressure plate 33a and the table 33b. The substrates W2 and W1 are bonded in this manner.

Each load cell 31 measures the load applied from the first support plate 25 at the time of pressing the substrates W2 and W1 and informs a press control unit 41 of the measured value. The press control unit 41 sums the four measured values to calculate the total load that acts on the four load cells 31. When the substrates W1 and W2 are not pressed, the total load is the total (A+B) of the weight “A” of the various members supported on the support arm 28 (the first support plate 25, the linear guides 24a and 24b, the second support plate 26, the suspension rods 34, the level adjusters 40, the pressure plate 33a and the substrate W2) and a load “B” which acts on the pressure plate 33a via the suspension rods 34 and is based on the difference between the pressure in the vacuum process chamber 32 and atmospheric pressure. The load B is proportional to the thickness (cross-sectional area) of the suspension rod 34.

When the vacuum process chamber 32 is depressurized (evacuated), the load B of about 1 kg/cm² is applied to the pressure plate 33a via the suspension rods 34. The load B is applied to the four load cells 31 via the second support plate 26, the linear guides 24a and 24b and the first support plate 25. Therefore, the four load cells 31 detect the total of the weight A and the load B together.

At the time the substrates W1 and W2 are bonded, the total load (A+B) is reduced by reaction force D of the substrates W1 and W2. Therefore, the actual pressing load applied to the substrates W1 and W2 is calculated from changes in the measured values from the four load cells 31.

The resolution of each load cell 31 is about 0.05%. According to the present embodiment, therefore, the total load is detected with the resolution of about 1 kg in a case where a total load of 2000 kg acts on each load cell 31.

The press control unit 41 computes the pressing load applied to the substrates W1 and W2 based on electric measurement signals each representing the measured value from the associated load cell 31. The press control unit 41 supplies a motor drive signal to a motor driver 42 while monitoring the pressing load. The motor driver 42 generates a predetermined number of pulse signals in accordance with the motor drive signal and sends the pulse signals to the pressure motor 27. The pressure motor 27 is driven in response to the pulse signals. When the pressure motor 27 receives one pulse signal, the support arm 28 or the pressure plate 33a is moved up or down by, for example, 0.2 micrometer.

The linear guides 24a and 24b are respectively provided with linear scales 43a and 43b for detecting the position of the pressure plate 33a. The linear scales 43a and 43b detect the relative position (distance) between the table 33b and the pressure plate 33a based on the detected positions of the linear guides 24a and 24b and output the results (positional data) to a display unit 44.

The display unit 44 is connected to a reference level sensor 45 provided on the pressure plate 33a. The display unit 44 stores the target position of the pressure plate 33a beforehand. The target position is the position of the pressure plate 33a when the pressure plate 33a is separated from the table 33b by the distance that is equal to the sum of the thicknesses of both substrates W1 and W2 and the target cell gap. The display unit 44 calculates the relative position of the pressure plate 33a with respect to the target position from the target position and the computation results from the linear scales 43a and 43b.

The press control unit 41 determines whether the gap between the substrates W1 and W2 being bonded and the pressing load are adequate or not while monitoring the position of the pressure plate 33a based on the relative position. When the relationship between the pressing load and the substrate gap is found to be beyond a predetermined allowable range based on the adequate relationship range between the pressing load and the substrate gap which has been acquired beforehand through experiments, the press control unit 41 determines that a bonding abnormality has occurred and stops the pressing process.

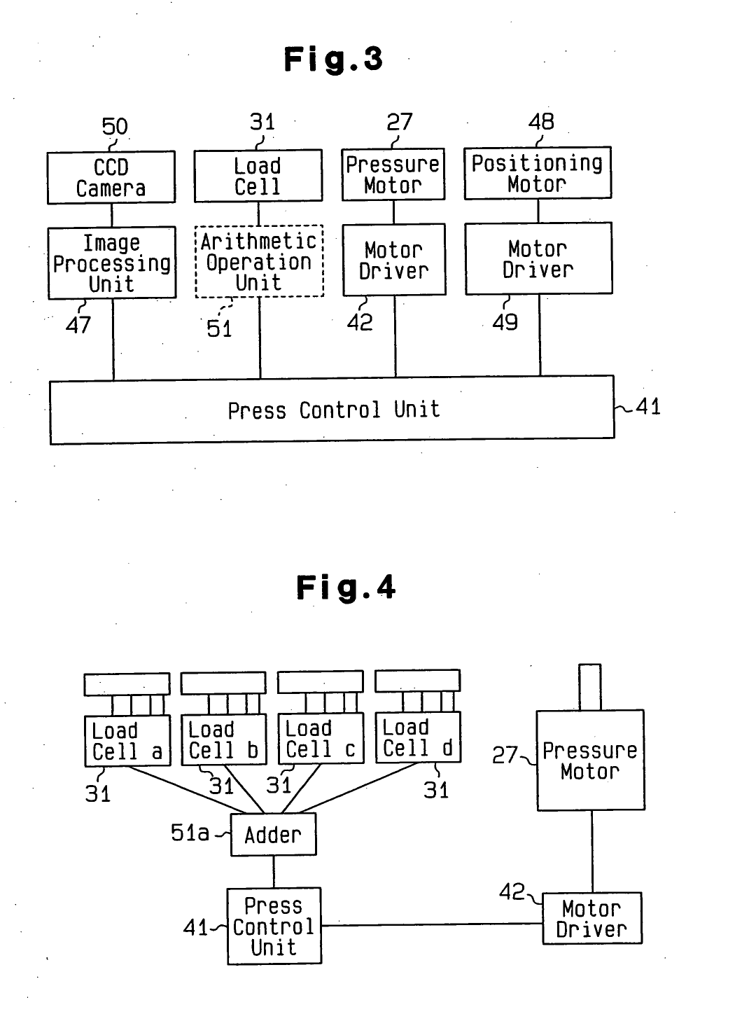

Referring to FIG. 3. the other control mechanisms of the press machine 17 will be elaborated below. Like or same reference numerals are used to indicate those structural portions which are the same as those explained above in connection with FIG. 2 and their detailed description will be partly omitted.

The press control unit 41 generates the motor drive signal based on the total load from the four load cells 31, and sends the motor drive signal to the motor driver 42. The motor driver 42 sends the generated pulse signals to the pressure motor 27 in response to the motor drive signal, causing the pressure motor 27 to rotate in the direction to move the pressure plate 33a up or down.

The press machine 17 includes CCD cameras 50 which detect image of alignment marks formed on both substrates W1 and W2. At the time the substrates W1 and W2 are bonded, the CCD cameras 50 sense the alignment marks on the substrates W1 and W2 and output image data thereof to an image processing unit 47. The press control unit 41 generates a stage drive signal for driving a positioning motor 48 in accordance with the calculation result (calculated data of the amount of positional deviation) from the image processing unit 47 and sends the stage drive signal to a motor driver 49. The motor driver 49 sends a predetermined number of pulse signals, generated in accordance with the stage drive signal, to the positioning motor 48. As the positioning motor 48 is driven, the positioning stage 36 and the table 33b are moved. Both substrates W1 and W2 are aligned in this manner.

Instead of directly supplying the measured value from each load cell 31 to the press control unit 41, the measured value from each load cell 31 may be supplied to an arithmetic operation unit 51 (FIG. 3) which adds the measured values from the individual load cells 31. Alternatively, as shown in FIG. 4, an adder 51a may be connected between the four load cells 31 (load cells a to d) and the press control unit 41. The adder 51a informs the press control unit 41 of the total load of the measured values from the load cells 31. Based on the total load, the press control unit 41 determines whether or not to drive the pressure motor 27 and generates the motor drive signal as needed. In this case, the press control unit 41 does not require a computation based on the measured values from the load cells 31 and can thus avoid a response delay so that the pressure motor 27 is driven accurately with high response.

The layout of the load cells 31 will be discussed next.

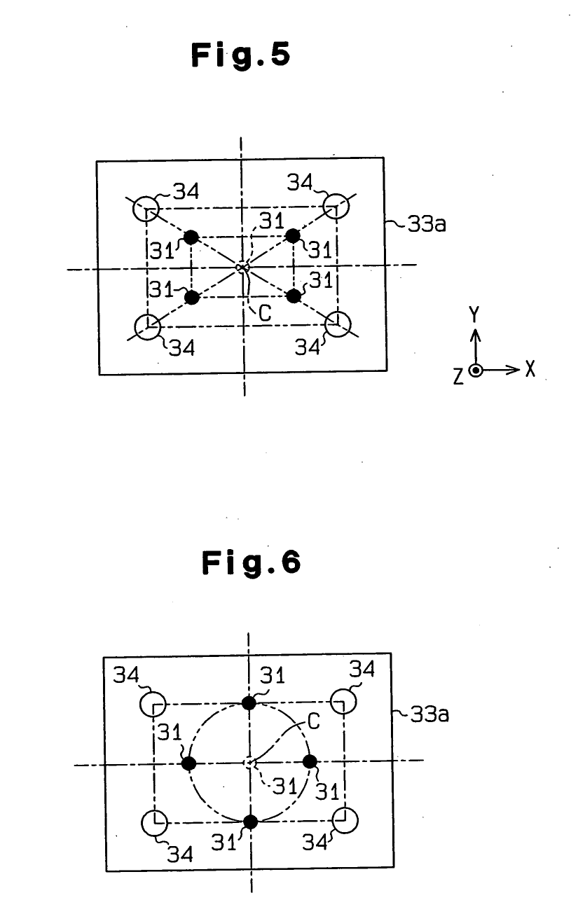

FIG. 5 shows the positions of the load cells 31 (black marks) that are projected on the pressure plate 33a and the positions of the suspension rods 34 (white marks). The four suspension rods 34 are provided at equal distances from the center C of the pressure plate 33a. The four load cells 31 are provided at equal distances from the center C of the pressure plate 33a and on diagonal lines that connect the suspension rods 34. Therefore, the load cells 31 are symmetrical about the XZ plane that passes through the center C of the pressure plate 33a and are also symmetrical about the YZ plane that passes through the center C of the pressure plate 33a. It is most desirable that the projected positions of the load cells 31 are in the vicinity of the projected positions of the suspension rods 34.

The weight A is evenly distributed to the four load cells 31. Even when the vacuum process chamber 32 is depressurized, the load B that acts on the four suspension rods 34 is evenly distributed among the four load cells 31. During bonding, the pressure plate 33a is kept horizontal with high precision. In a case where the pressure plate 33a is tilted due to entry of foreign matter or a mechanical deviation that occurred during bonding, the inclination can be checked with high precision from the sum of the measured values or loads of the load cells 31.

As shown in FIG. 6, the load cells 31 may be laid out concentrically and symmetrical with respect to the center C of the pressure plate 33a.

In a case where an odd number of load cells 31 are used, it is preferable that one load cell should be arranged at the center C of the pressure plate 33a (FIGS. 5 and 6).

Pressure control using image pickup means will be discussed below.

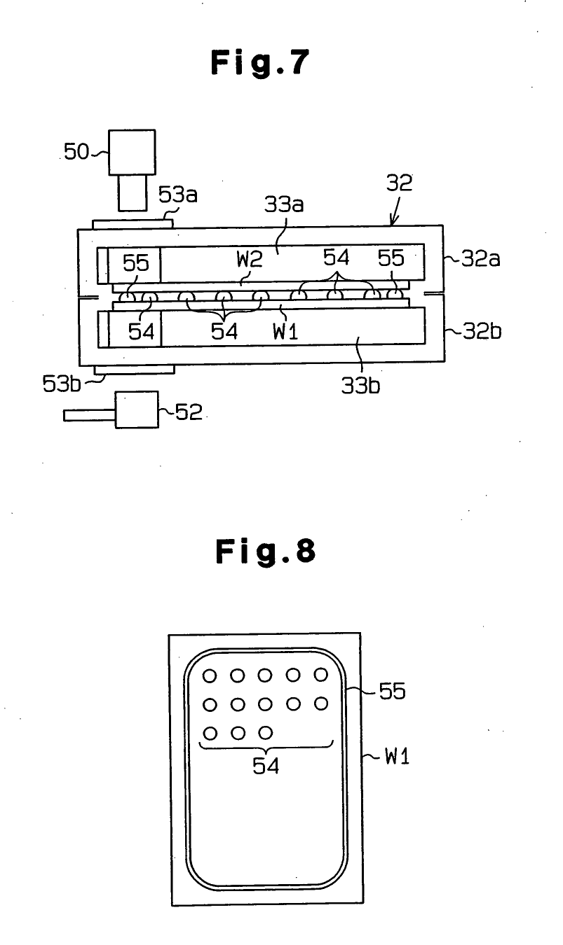

As shown in FIG. 7, the press machine 17 has a device which monitors the pressing load, i.e., the CCD camera 50. In this embodiment, the CCD camera 50 is shared with the CCD cameras 50 (see FIG. 3) that are used to sense the alignment marks of the substrates W1 and W2 for alignment of the substrates W1 and W2.

The CCD camera 50 is located above the upper container 32a and an illumination unit 52 is located under the lower container 32b. The CCD camera 50 picks up the image of the peripheral portions of the substrates W1 and W2, particularly, a seal 55 which is pressed at the time of bonding the substrates W1 and W2, through inspection windows 53a and 53b respectively provided in the upper container 32a and the lower container 32b. Based on image data of the seal 55 sensed by the CCD camera 50, the width of the seal 55 is measured and is used as an index representing the degree of flattening of the seal 55. Accordingly, the estimated value for the pressing load is acquired. Based on the estimated value, it is determined whether or not the pressing load to be applied to both substrates W1 and W2 is adequate. The relationship between the flattened width of the seal 55 and the pressing load has been acquired beforehand through experiments in accordance with the sizes of the substrates W1 and W2 and the type or the like of a liquid crystal 54 or the seal 55, and the adequate value for the pressing load is determined based on this relationship.

The CCD camera 50 is one of the four CCD cameras 50 which respectively sense the seal 55 at the four comers of the substrates W1 and W2. As the four CCD cameras 50 monitor the degree of flattening of the seal 55 at four locations, it is possible to accurately detect if the frame of the seal 55 is firmly attached to both substrates W1 and W2 evenly. It is therefore possible to detect the degree of parallelization of the pressure plate 33a and the table 33b from the degree of flattening of the seal 55.

By monitoring the degree of flattening of the seal 55, the timing for curing the seal 55 by irradiation ultraviolet rays on the seal 55 after bonding the substrates W1 and W2 can be set to the proper timing. Immediately after bonding, the liquid crystal 54 has not yet diffused entirely between the substrates W1 and W2 and the cell gap between both substrates W1 and W2 has not reached a predetermined value (target gap). The timing at which ultraviolet rays are to be irradiated on the seal 55 is determined in accordance with the diffusion speed of the liquid crystal 54. If the irradiation of the ultraviolet rays is early, the seal 55 is cured before the gap between both substrates W1 and W2 reaches the predetermined cell gap. If the irradiation of the ultraviolet rays is late, on the other hand, the liquid crystal 54 contacts the uncured seal 55, which leads to display defects of the peripheral portion of the panel. The optimal illumination timing for the ultraviolet rays is determined from the degree of flattening of the seal 55 that is monitored by the CCD cameras 50 so that the seal 55 can be cured with the proper timing.

After the substrates W1 and W2 are bonded, the pressure plate 33a releases the electrostatic chuck force with respect to the substrate W2 and separates the substrate W2. At this time, the CCD cameras 50 may monitor the shape of the seal 55. In this case, the positional deviation of the substrates W1 and W2 is prevented from occurring due to the electrostatic chuck force remaining on the pressure plate 33a and the substrate W2.

A description will now be given of press control at the time of bonding the substrates W1 and W2.

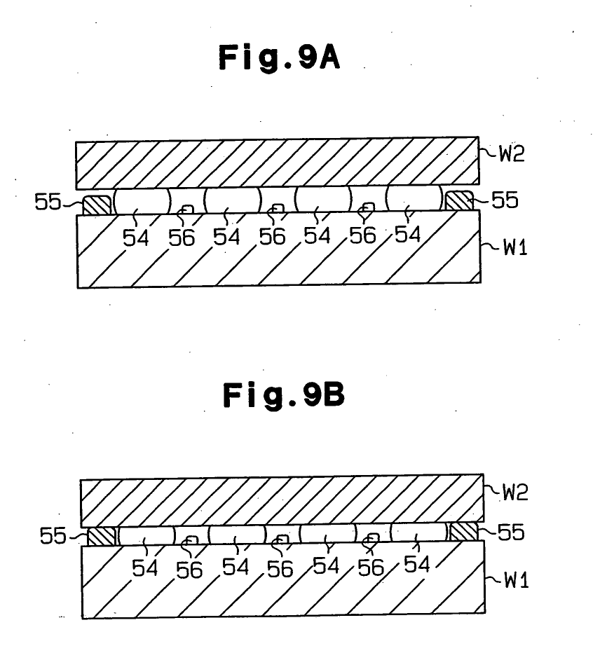

As shown in FIG. 8, the seal 55 is applied in the form of a frame to one of the substrates W1 and W2 (the substrate W1 in this embodiment). The liquid crystal 54 is dropped at plural locations in the frame of the seal 55 by the amount of, for example, 5 mg each. Then, as shown in FIGS. 9A and 9B, the substrates W1 and W2 are pressed to have a predetermined cell gap which is restricted by spacers 56 formed on the substrate W1.

As shown in FIG. 9A, the liquid crystal 54 is dropped in such a way that the liquid crystal 54 becomes higher than the height of the seal 55. Therefore, alignment of the substrates W1 and W2 during bonding is carried out in such a way that the substrate W2 contacts only the liquid crystal 54 and does not contact the seal 55. Specifically, the pressing load when the substrate W2 would contact only the liquid crystal 54 has been acquired empirically beforehand and the downward movement of the pressure plate 33a is stopped when the pressing load computed from the measured values from the load cells 31 reaches the empirically acquired pressing load. At this time, it is preferable that the CCD cameras 50 monitor the contact of the substrate W2 with the seal 55. With the substrate W2 in contact with only the liquid crystal 54, the alignment of the substrates W1 and W2 is executed while the alignment marks of the substrates W1 and W2 are being sensed by the CCD cameras 50. Thereafter, the substrates W1 and W2 are pressed until nearly the entire surface of the seal 55 is compressed, after which the vacuum process chamber 32 is released. As a result, the substrates W1 and W2 are compressed to the predetermined cell gap that it is restricted to by the spacers 56.

If the substrates W1 and W2 are aligned while the substrates W1 and W2 are in contact with the seal 55 as shown in FIG. 9B, shearing force acts on the seal 55. When the vacuum process chamber 32 is released, the shearing force that is acting on the seal 55 is released, thereby causing positional deviation of the substrates W1 and W2. In this embodiment, the positional deviation of the substrates W1 and W2 is prevented during a period from the point of bonding of the substrates to the point at which the seal 55 is cured, by aligning the substrates W1 and W2 without causing the substrate W2 to contact the seal 55.

As the load when the substrate W2 contacts only the liquid crystal 54 is detected, it is possible to detect the position of the pressure plate 33a when the substrate W2 does not contact the seal 55 and when the gap between the substrates W1 and W2 is minimized. Alignment in this state can allow the substrates W1 and W2 to be bonded together accurately and can prevent the positional deviation of the substrates W1 and W2 after bonding.

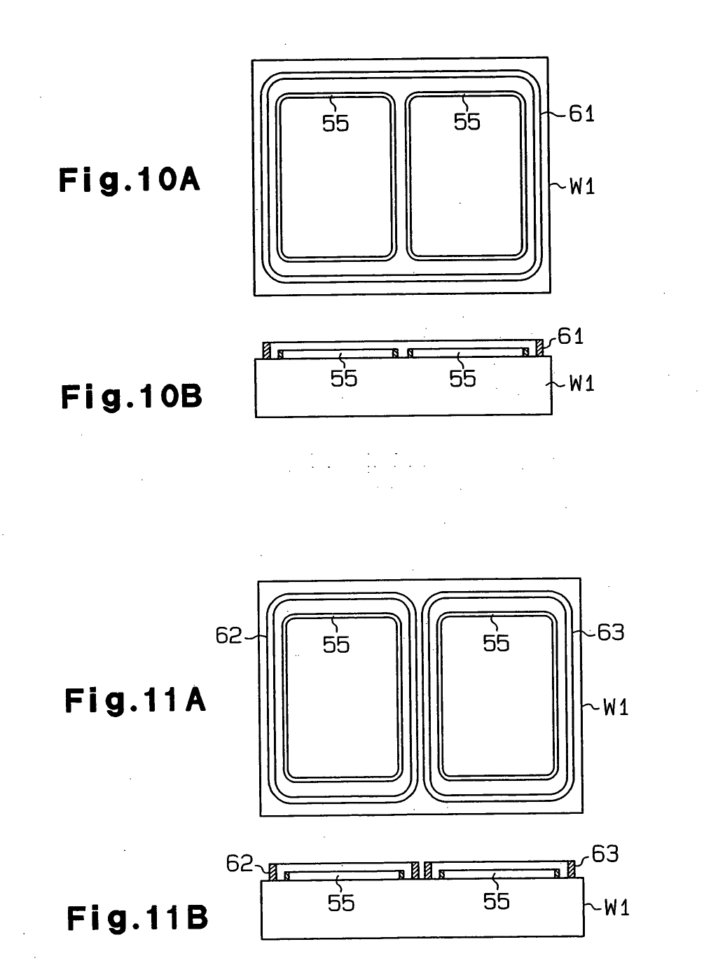

As shown in FIG. 10A, the frame of an outer seal 61 which surrounds the seal 55 may be formed on the substrate W1. When the substrate W1 has two cells (the number of panels to be formed is two), two inner seals 55 that define the areas for the liquid crystal 54 to be sealed in the two cells are formed on the substrate W1. The outer seal 61 is applied to the substrate W1 in an annular form in such a way as to enclose the two inner seals 55. The application position of the outer seal 61 is set at an unnecessary portion outside the inner seals 55. It is preferable that the height and width of the outer seal 61 should be greater than those of the inner seals 55 as shown in FIG. 10B.

The alignment of the substrates W1 and W2 is preferably carried out when the substrate W2 comes in contact with only the outer seal 61. This prevents the substrates W1 and W2 from being damaged during bonding by the influences of the thickness distribution of the substrates W1 and W2 and the bending of the substrate W2. That is, in a case where positional deviation of the substrates W1 and W2 has occurred or parallelism is lost at the time of bonding, such an abnormality can be detected when the substrate gap is larger (when the pressing force is lower) by detecting the load by using the outer seal 61. It is therefore possible to stably bond the substrates W1 and W2. As the outer seal 61 has an effect of forming a vacuum area between the inner and outer seals 55 and 61, it is possible to suppress the positional deviation of the substrates W1 and W2 even at the time of curing the seals 55 after bonding the substrates, thereby securing a stable cell gap.

If the inner seals 55 are set high, the size of the product increases or the seals 55 may not be flattened to the predetermined cell gap by atmospheric pressure. There is a possibility that the seals 55 are not compressed to the predetermined cell gap due to the pressure of the liquid crystal 54 even after the liquid crystal 54 is diffused. It is therefore preferable to use the outer seal 61 without making the inner seals 55 higher.

There may be a case where the inner seals 55 reach a film which does not pass light (the peripheral portion or the like of a black matrix) and which is formed on the substrate W2. In this case, the degree of flattening of the outer seal 61 may be monitored by the CCD cameras 50. As the outer seal 61 is larger than the inner seal 55, the load at the time of bonding is detected accurately.

In a case where there is a certain degree of distance between adjoining cells on the substrate W1 having a plurality of cells, a plurality of outer seals 62 and 63 may be applied outside plural inner seals 55 which are respectively provided in association with the plural cells, as shown in FIGS. 11A and 11B.

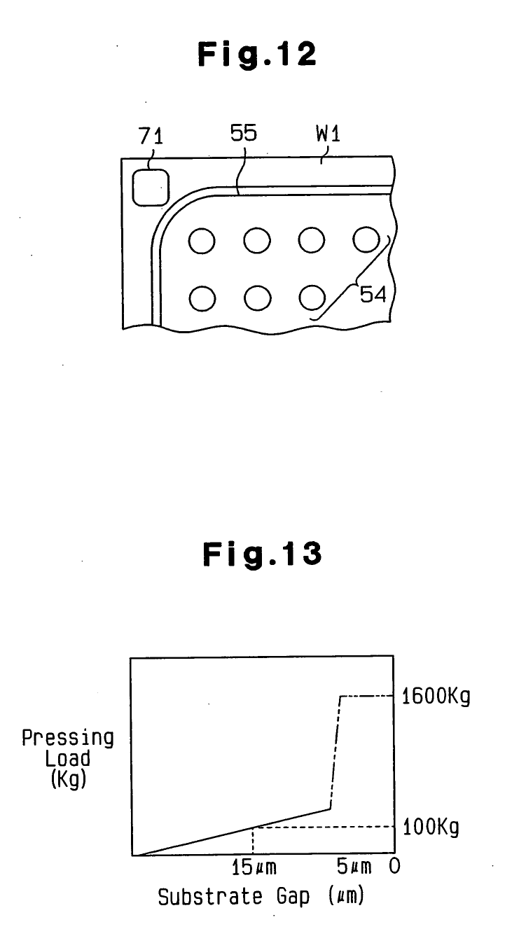

As shown in FIG. 12, four outer seals 71 may be applied to outside the inner seals 55 and at the four corners of the substrate W1.

A description will be given of the gap between the substrates W1 and W2 and the pressing load.

The pressing load on the substrates W1 and W2 should be set to the optimal value in consideration of the gap between the substrates W1 and W2. This is because if the pressing load is too high (the amount of downward movement of the pressure plate 33a is large), the substrates W1 and W2 may be damaged, whereas if the pressing load is too low (the amount of downward movement of the pressure plate 33a is small), the substrates W1 and W2 are not compressed to the predetermined cell gap after the vacuum process chamber 32 is released. Before performing substrate bonding, therefore, the correlation between the pressing load on the substrates W1 and W2 and the gap between the substrates should be acquired beforehand through experiments. FIG. 13 is a graph showing the results of the experiments. The horizontal scale represents the substrate gap and the vertical scale represents the pressing load. The pressing load before the liquid crystal 54 starts being flattened is 0 kg. As the liquid crystal 54 and the inner seals 55 are compressed, the pressing load rises. When the substrate gap approximately reaches the target size (5 micrometers), the substrate W2 contacts the spacers 56 and the pressing load rises abruptly. If the substrates W1 and W2 are pressed further, the substrates W1 and W2 and the pressure plate 33a will be damaged. To bond the substrates W1 and W2 without producing bubbles and damages, the substrates W1 and W2 should preferably be bonded within the range where the pressing load rises gently (nearly linearly).

The pressing load when approximately the entire surface of the seal 55 is compressed while being in contact with the substrate W2 is preferably acquired empirically. In this embodiment, the pressing load becomes 100 kg when the substrate gap is about 15 micrometers. When the load cells 31 detect the pressing load, the downward movement of the pressure plate 33a is stopped, thus stopping pressing of the substrates W1 and W2.

It is preferable that the pressing load be increased stepwise in consideration of the positional deviation and the inclination of the substrates W1 and W2. When the pressing load detected by the load cells 31 is lower than the target pressing load of 100 kg (e.g., when the pressing load reaches 20 kg or 50 kg), for example, the downward movement of the pressure plate 33a is stopped temporarily to check the pressing load again.

The pressing load of 20 kg is the load when the substrate gap is about 50 to 30 micrometers which is slightly larger than the initial height of the seal 55 and at which the substrate W2 contacts only the liquid crystal 54. The pressing load of 50 kg is the load immediately before the substrate W2 contacts the seal 55, i.e., the load when the substrate gap is about 30 to 15 micrometers. The substrate gap is acquired from the pressing load (20 kg, 50 kg) based on the graph in FIG. 13.

In a case where the pressing load rapidly increases or the difference among the measured values from the plural load cells 31 becomes large (e.g., in a case where the maximum difference among the measured values reaches about 10%) when the pressing load reaches 20 kg or 50 kg, pressing of the substrates W1 and W2 is stopped. In a case where no abnormality has occurred during pressing, on the other hand, the pressure plate 33a is lowered until the pressing load reaches the target value (100 kg). After pressing of the substrates W1 and W2 is stopped, the vacuum process chamber 32 is released. The substrates W1 and W2 are compressed to the target cell gap by atmospheric pressure.

In a case where both substrates W1 and W2 have a size of 650 mm×830 mm and the inner seals 55 are formed 10 mm inside the edge of the associated substrate, the substrates W1 and W2 are pressed by the load of about 5100 kg, which is caused by atmospheric pressure. By way of contrast, the pressing load before the vacuum process chamber 32 is released is about 100 kg. Even if a load is locally applied to the substrates W1 and W2 at the time of carrying out pressing under a reduced pressure, therefore, the substrates W1 and W2 are not largely influenced.

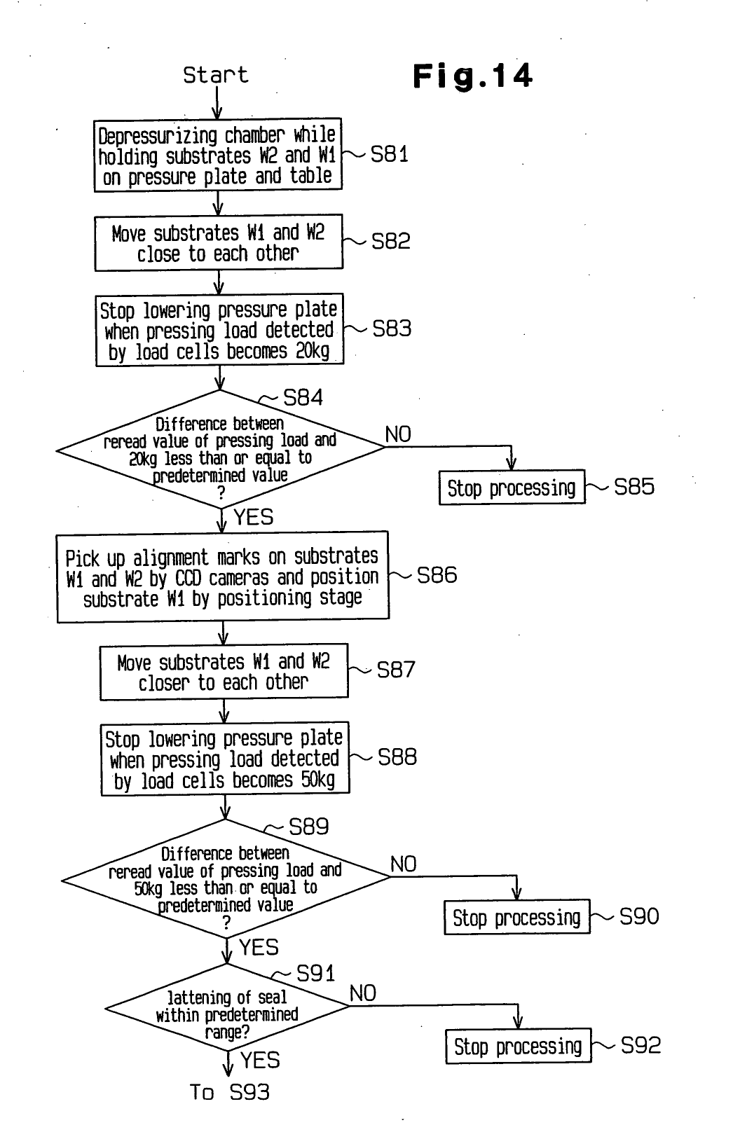

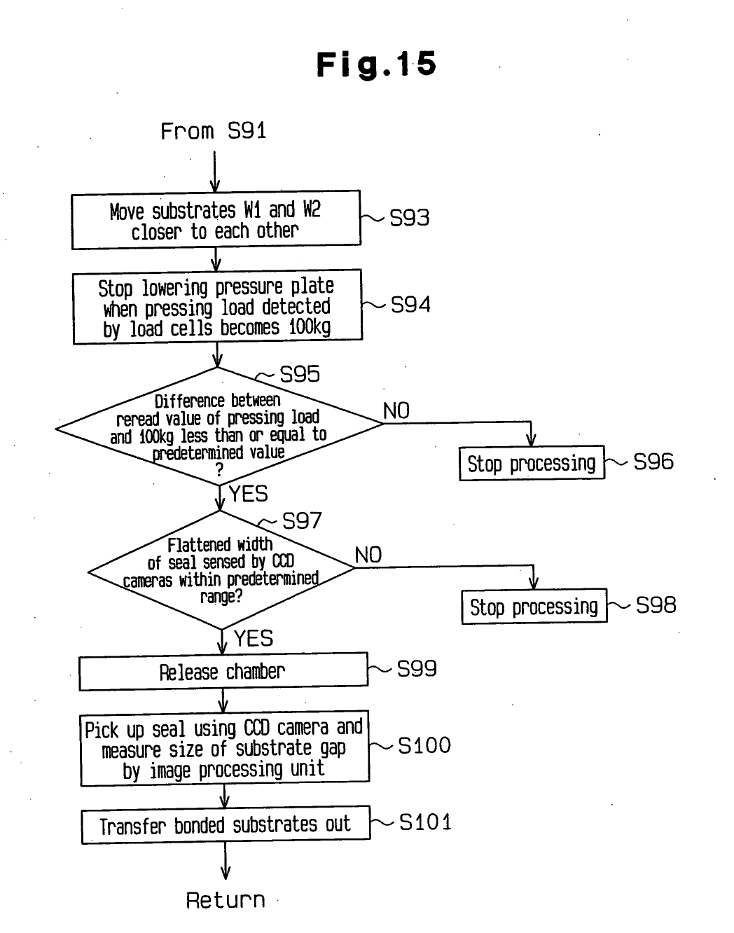

By referring to FIGS. 14 and 15, a method of bonding the substrates W1 and W2 will be discussed.

In step S81, the substrates W2 and W1 are respectively held on the pressure plate 33a and the table 33b. The press control unit 41 drives the pressure motor 27 to lower the upper container 32a to dose the vacuum process chamber 32 and depressurize the vacuum process chamber 32.

In step S82, the press control unit 41 moves the pressure plate 33a downward to cause the substrates W1 and W2 to further approach each other.

In step S83, the press control unit 41 calculates the pressing load based on the measured values from the load cells 31. When the calculated pressing load reaches 20 kg, the press control unit 41 stops lowering the pressure plate 33a. The press control unit 41 monitors the degree of flattening of the seal 55 based on picked-up data from the CCD cameras 50.

In step S84, the press control unit 41 calculates the pressing load again based on the measured values from the load cells 31 and checks if the difference between the pressing load and 20 kg lies within a predetermined range. When the difference is greater than the predetermined range (NO in step S84), the press control unit 41 stops lowering the pressure plate 33a and stops pressing the substrates W1 and W2 (step S85). In this case, there is a possibility that the parallelism of the substrates W1 and W2 has been lost due to a variation in the thickness of the substrates W1 and W2 or the seal 55 or a problem occurred in the press machine 17, so that the location of an abnormality is checked.

When the decision in step S84 is YES, the press control unit 41 drives the positioning stage 36 to align the substrates W1 and W2 while picking up the images of the alignment marks of the substrates W1 and W2 by means of the CCD camera 50 (step S86).

In step S87, the press control unit 41 moves the pressure plate 33a downward. When the computed pressing load reaches 50 kg, the press control unit 41 stops lowering the pressure plate 33a (step S88). The press control unit 41 monitors the degree of flattening of the seal 55 from the data picked-up from the CCD cameras 50.

The press control unit 41 computes the pressing load again based on the measured values from the load cells 31 and determines whether or not the difference between the pressing load and 50 kg lies within a predetermined range (step S89). When the difference is greater than the predetermined range (NO in step S89), the press control unit 41 stops lowering the pressure plate 33a and stops pressing the substrates W1 and W2. In this case, there is a possibility that parallelism of the substrates W1 and W2 has been lost, so that the location of an abnormality is checked (step S90).

When the decision in step S89 is YES, on the other hand, the press control unit 41 checks if the flattened width of the seal 55 based on the picked-up data from the CCD cameras 50 lies within a predetermined range (step S91). When the flattened width of the seal 55 is greater than the predetermined range, the press control unit 41 stops pressing the substrates W1 and W2 (step S92). When the decision in step S91 is YES, on the other hand, the press control unit 41 moves the pressure plate 33a downward to cause the substrates W1 and W2 to further come doser to each other (step S93). When the calculated pressing load reaches 100 kg, the press control unit 41 stops lowering the pressure plate 33a (step S94). The press control unit 41 monitors the degree of flattening of the seal 55 based on picked-up data from the CCD cameras 50.

In step S95, the press control unit 41 calculates the pressing load again based on the measured values from the load cells 31. When the difference between the computed pressing load and the pressure value of 100 kg is greater than the predetermined range (NO in step S95), the press control unit 41 stops lowering the pressure plate 33a (step S96). In this case, there is a possibility that parallelism of the substrates W1 and W2 has been lost, so that the location of an abnormality is checked.

When the decision in step S95 is YES, on the other hand, the press control unit 41 checks if the flattened width of the seal 55 based on the picked-up data from the CCD cameras 50 lies within a predetermined range (step S97). When the flattened width of the seal 55 is greater than the predetermined range, the press control unit 41 stops pressing the substrates W1 and W2 (step S98). When the decision in step S97 is YES, on the other hand, the press control unit 41 moves the pressure plate 33a upward to release the vacuum process chamber 32 (step S99). The substrates W1 and W2 are compressed to the predetermined cell gap by the difference between atmospheric pressure and the pressure (vacuum) in the space between the substrates.

The image processing unit 47 calculates the flattened width of the seal 55 based on the picked-up data from the CCD cameras 50 and estimates the gap between the substrates W1 and W2 from this flattened width. The press control unit 41 reads the estimated value of the gap between the substrates W1 and W2 (step S100). The press control unit 41 transfers the bonded substrates W1 and W2 to the transfer equipment (step S101).

The first embodiment has the following advantages.

(1) The pressure plate 33a and the table 33b are provided facing each other in the vacuum process chamber 32. The pressure plate 33a is suspended from the second support plate 26 via the suspension rods 34. The table 33b is supported on the positioning stage 36 via the legs 37. The upper container 32a is suspended from the second support plate 26 via the upper bellows 35. The lower container 32b is supported on the positioning stage 36 via the lower bellows 38. The second support plate 26 and the positioning stage 36 are supported on the base plate 21 and the gate 22 which have a high rigidity. Even in a case where the vacuum process chamber 32 is depressurized and deformed, the deformation is absorbed by the bellows 35 and 38. Therefore, the depressurization-originated influence of deformation of the vacuum process chamber 32 does not act on the pressure plate 33a and the table 33b and does not therefore influence the relative position and parallelism of the substrates W1 and W2. With vibrations from outside the press machine 17 absorbed by the bellows 35 and 38, vibrations are prevented from being transmitted to the pressure plate 33a and the table 33b. This suppresses positional deviation of the substrates W1 and W2 and keeps the substrates W1 and W2 parallel to each other.

(2) The substrates W1 and W2 are pressed while the measured values from the load cells 31 are monitored until the gap between the substrates W1 and W2 reaches the gap at which the substrates W1 and W2 contact the entire seal 55. The vacuum process chamber 32 is released while the relative position and parallelism of the substrates W1 and W2 are maintained. Thereafter, the substrates W1 and W2 are compressed to the target cell gap due to the difference between atmospheric pressure and the pressure in the space between the substrates. Because the pressing load after the vacuum process chamber 32 is released to atmospheric pressure acts evenly on the entire substrates W1 and W2, both substrates W1 and W2 are therefore bonded accurately without being damaged. As the pressing load until both substrates W1 and W2 contact the seal 55 is significantly lower than the pressing load after release of the vacuum process chamber 32 to atmospheric pressure, damage on the substrates W1 and W2 is relatively small even if the substrates W1 and W2 are bonded with a mechanical positional deviation occurring in the press machine 17 or while the substrates W1 and W2 are not parallel to each other.

(3) The pressing load is monitored based on the measured values from the load cells 31, the position of the pressure plate 33a detected by the linear scales 43a and 43b and the degree of flattening of the seal 55 sensed by the CCD cameras 50. In a case where the pressing load on the substrates W1 and W2 is detected to be abnormal based on the monitoring result, further pressing is stopped, thus preventing the pressure plate 33a, the table 33b and the substrates W1 and W2 from being damaged.

(4) The load cells 31 are provided at equal distances from the center C of the pressure plate 33a and on diagonal lines that connect the suspension rods 34. This allows a well-balanced load (weight) to be applied to the plural load cells 31 and allows a well-balanced load (atmospheric pressure) to be applied to the plural load cells 31 in the process of depressurizing the vacuum process chamber 32. Therefore, the pressure plate 33a and the table 33b are kept parallel to each other regardless of the pressure in the vacuum process chamber 32. As the parallelism of the pressure plate 33a relative to the table 33b, which may be lost due to entry of a foreign matter or mechanical deviation of the press machine 17, is inspected based on the measured values from the plural load cells 31 so that the substrates W1 and W2 are bonded with high precision while the parallelism is maintained.

(5) Alignment of the substrates W1 and W2 is carried out when the pressure plate 33a is in the position where the gap between the substrates W1 and W2 is at a minimum within the range in which the substrate W2 contacts the liquid crystal 54 but does not contact the seal 55. Because shearing force does not act on the seal 55, the positional deviation of the substrates W1 and W2 after release of the vacuum process chamber 32 to atmospheric pressure is prevented. This allows the substrates W1 and W2 to be bonded with high precision.

(6) As the outer seal 61 (62, 63) which is higher and thicker than the inner seals 55 is provided outside the inner seals 55, it is possible to detect the pressing load accurately and provide a large margin for the substrate gap (the stop position of the pressure plate 33a) at the time pressing is stopped. In a case where pressing is abnormal, therefore, the abnormality can be detected earlier. Even in a case where the inner seals 55 reach the light shielding film of the substrate W2, the degree of flattening of the outer seal 61 (62, 63) can be sensed by the CCD cameras 50.

(7) As the gap between the substrates W1 and W2 is kept approximately constant based on the measured values from the load cells 31, the time needed to spread the liquid crystal 54 after the vacuum process chamber 32 is released to atmospheric pressure becomes approximately constant. This can allow the timing for irradiation of ultraviolet rays to be made approximately constant, so that the process of curing the seal 55 can be performed at the optimal timing. It is also possible to prevent adhesion of the seal 55 from becoming insufficient due to inadequate curing. This makes it possible to efficiently activate the bonded substrate fabricating apparatus 11 in case of continuously carrying out bonding of the substrates W1 and W2.

(8) Because the measured values from the load cells 31 are not influenced by deformation of the vacuum process chamber 32 because of the action of the bellows 35 and 38, the reliability of the measured values from the load cells 31 is improved. Further, the press control unit 41 can monitor the pressing load on the substrates W1 and W2 with high precision.

A description will be given below of a press machine 121 according to a second embodiment of the present invention, mainly on differences from the press machine 17 of the first embodiment and omitting descriptions on the same structures.

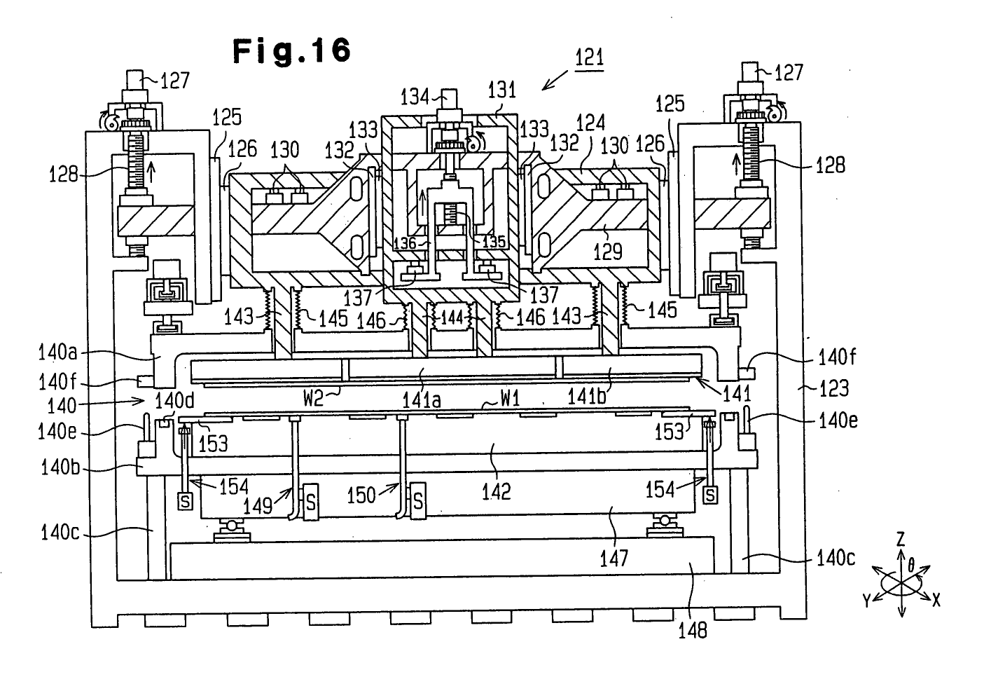

As shown in FIG. 16, the press machine 121 has a main support gate 123 attached with guide rails 125 and an inner support frame 124 attached with linear guides 126. The inner support frame 124 is movable up and down with respect to the main support gate 123.

Plural (two shown in the drawing) pressure motors 127 are provided at the main support gate 123. Each pressure motor 127 turns an associated ball screw 128. A support plate 129 is moved up and down in accordance with rotational direction of the ball screw 128. The inner support frame 124 is supported on the support plate 129 via plural (four shown in the diagram) load cells 130.

A central support frame 131 is provided in the center of the inner support frame 124. Attached to the central support frame 131 are linear guides 133 which are movable up and down along guide rails 132 attached to the support plate 129. That is, the central support frame 131 can move up and down with respect to the support plate 129 and the inner support frame 124.

The support plate 129 is provided with a pressure motor 134 which turns a ball screw 135 coupled to a support member 136. The rotation of the ball screw 135 causes the support member 136 to move up and down. The central support frame 131 is supported on the support member 136 via plural (two shown in the diagram) load cells 137. It is preferable that the load cells 130 and 137 be laid out as shown in FIG. 5 or FIG. 6.

A vacuum process chamber 140 is provided below the inner and central support frames 124 and 131. The vacuum process chamber 140 is defined by an upper container 140a and a lower container 140b which are separable. The lower container 140b is supported by a plurality of support rods 140c attached to the main support gate 123.

An O-ring 140d, which keeps the vacuum process chamber 140 airtight, is provided at the periphery of the opening of the lower container 140b. A positioning pin 140e provided at the lower container 140b is fitted in a positioning hole 140f formed in the upper container 140a when the vacuum process chamber 140 is closed. This causes the upper container 140a to be positioned with respect to the lower container 140b.

A pressure plate 141 and a table 142 are provided in the vacuum process chamber 140 and face each other. The pressure plate 141 holds the second substrate W2 (CF substrate) and the table 142 holds the first substrate W1 (TFT substrate). The pressure plate 141 and the table 142 hold the second substrate W2 and the first substrate W1 respectively by at least one of vacuum chuck force and electrostatic chuck force.

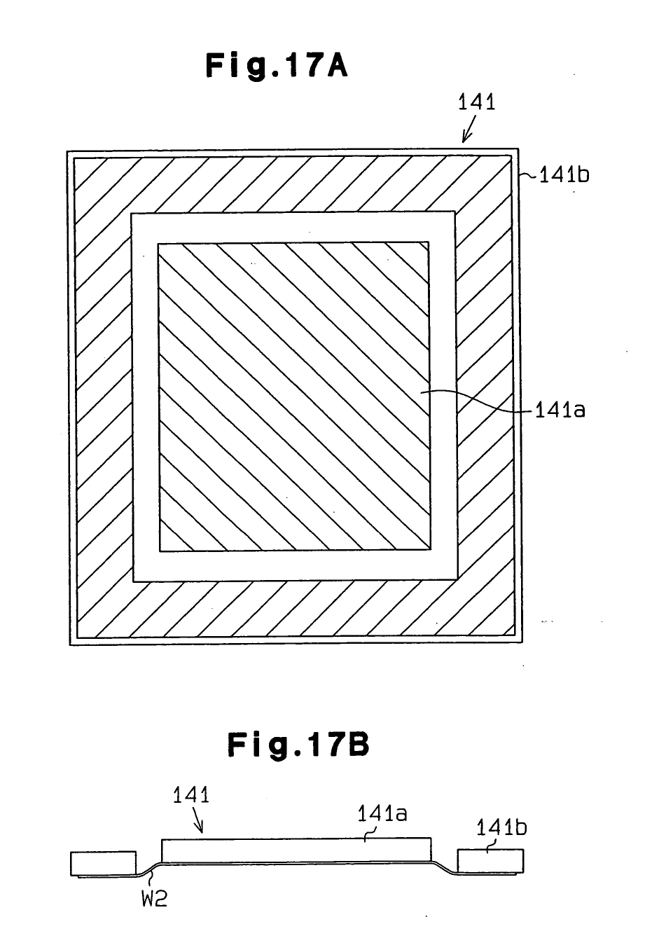

As shown in FIG. 17A, the pressure plate 141 has a central pressing portion 141a and a peripheral pressing portion 141b provided outside and apart from the central pressing portion 141a. The substrate W2 is held by the central pressing portion 141a and the peripheral pressing portion 141b which are indicated by hatching in FIG. 17A. The peripheral pressing portion 141b is supported on plural (two shown in the diagram) supports 143 that extend downward from the inner support frame 124. The central pressing portion 141a is supported on plural (two shown in the diagram) supports 144 that extend downward from the central support frame 131. The supports 143 are integral with the inner support frame 124, and the supports 144 with the central support frame 131.

Bellows 145 as an elastic member are provided between the inner support frame 124 and the upper container 140a in such a way as to surround the individual supports 143. Each bellows 145 has a flange portion at either end. Both flange portions are respectively coupled to the inner support frame 124 and the upper container 140a via O-rings which serve as sealing members.

Bellows 146 as an elastic member are provided between the central support frame 131 and the upper container 140a in such a way as to surround the individual supports 144. Each bellows 146 has a flange portion at either end. Both flange portions are respectively coupled to the central support frame 131 and the upper container 140a via O-rings which serve as sealing members. The bellows 145 and 166 are connected to the vacuum process chamber 140 airtightly.

The table 142 is provided in the lower container 140b and is moved horizontally and turned within the horizontal plane by a positioning stage 147. The positioning stage 147 is slidable and rotatable within the horizontal plane with respect to a base plate 148 secured to the main support gate 123, and supports the table 142 via plural supports (not shown). As the positioning stage 147 moves, therefore, the table 142 also moves horizontally and turns. The individual supports are surrounded by a bellows (not shown), which keeps the vacuum process chamber 140 airtight between the positioning stage 147 and the lower container 140b.

The main support gate 123, the inner support frame 124, the central support frame 131, the support plate 129, the support member 136 and the base plate 148 are formed of material which has sufficiently high rigidity.

Ultraviolet-ray irradiating devices 149 and 150 are provided on the table 142. The ultraviolet-ray irradiating device 149 faces the central pressing portion 141a of the pressure plate 141, and the ultraviolet-ray irradiating device 150 faces the peripheral pressing portion 141b. The ultraviolet-ray irradiating devices 149 and 150 are moved up and down by unillustrated cylinders. The ultraviolet-ray irradiating devices 149 and 150 irradiate ultraviolet rays onto the seal at the time of bonding the first and second substrates W1 and W2. The irradiation cures the seal to temporarily fix both substrates W1 and W2.

A lift plate 153 is provided at the outer periphery of the table 142. The top surface of the lift plate 153 is level with the top surface of the table 142 (which chucks the substrate W1). The outer edges of the lift plate 153 extend out of the table 142. The lift plate 153 is lifted above the table 142 by a lift mechanism 154.

The operation of the press machine 121 will be discussed below.

When the pressure motors 127 are driven, the support plate 129, the inner support frame 124 and the central support frame 131 are moved up and down with respect to the main support gate 123. When the pressure motor 134 is driven, the support member 136 and the central support frame 131 are moved up and down with respect to the support plate 129 and the inner support frame 124. Therefore, the inner support frame 124 and the central support frame 131 are moved up and down independently with respect to the main support gate 123. In other words, the central pressing portion 141a and the peripheral pressing portion 141b are moved up and down independently of each other while holding the substrate W2, as shown in FIG. 17B.

Each of the load cells 130 and 137 supplies the detected load to the press control unit (not shown).

When the vacuum process chamber 140 is depressurized, the load that is associated with the difference between the pressure in the vacuum process chamber 140 and the atmospheric pressure acts on the load cells 130 via the peripheral pressing portion 141b and the supports 143. The load cells 130 detect the sum of the load associated with the pressure difference and the load that is associated with the weight of the member supported on the support plate 129. The press control unit calculates the pressing load applied to both substrates W1 and W2 from the peripheral pressing portion 141b based on the decrease in the total load supplied from the load cells 130.

Likewise, when the vacuum process chamber 140 depressurized, the load that is associated with the difference between the pressure in the vacuum process chamber 140 and the atmospheric pressure acts on the load cells 137 via the central pressing portion 141a and the supports 144. The load cells 137 detect the sum of the load associated with the pressure difference and the load that is associated with the weight of the member supported on the support member 136. The press control unit calculates the pressing load applied to both substrates W1 and W2 from the central pressing portion 141a based on the decrease in the total load supplied from the load cells 137.

The press control unit controls the pressing load on both substrates W1 and W2 by controlling the motors 127 and 134 in accordance with the detection results from the load cells 130 and 137, as per the first embodiment. Further, the press control unit aligns both substrates W1 and W2 with each other by driving the positioning stage 147 based on image data from the CCD cameras 50 as has been described in the foregoing description referring to FIG. 3.

The linear guides 126 and 133 may be provided with linear scales which respectively detect the moving positions of the peripheral pressing portion 141b and the central pressing portion 141a. In this case, the press control unit may monitor the relative positions of the central pressing portion 141a and the peripheral pressing portion 141b with respect to the table 142 and determine whether the relationship between the gap between the substrates W1 and W2 and the pressing load is adequate or not.

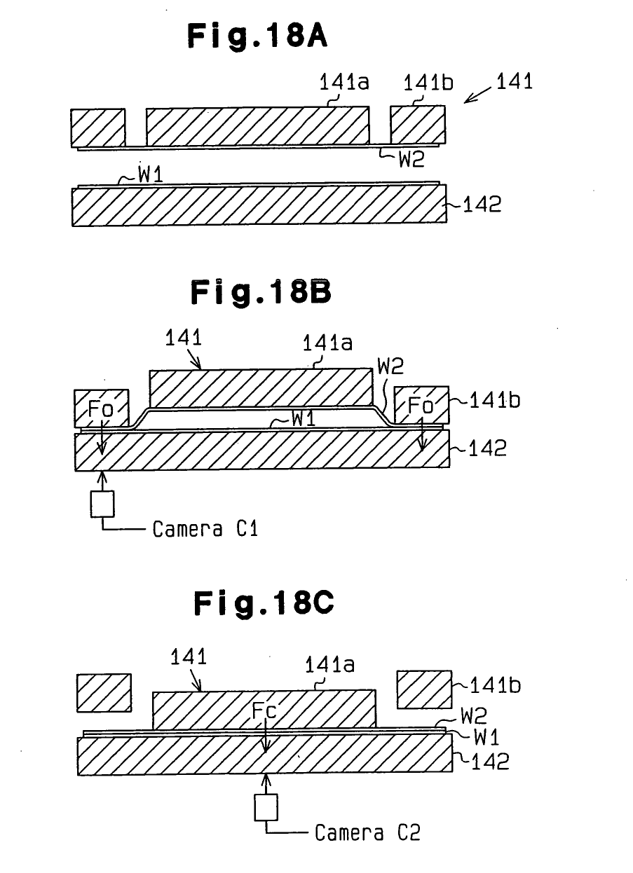

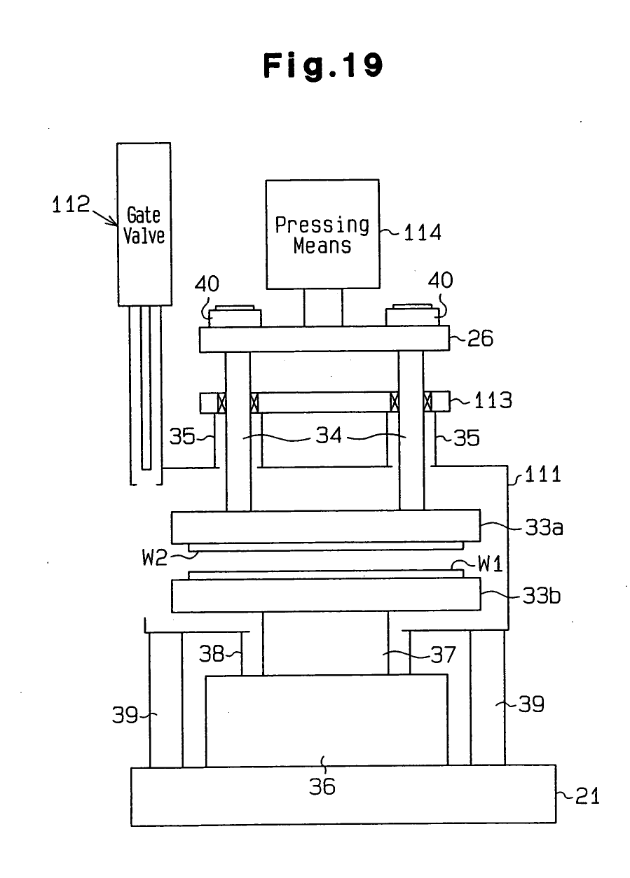

Bonding of both substrates W1 and W2 will now be discussed referring to FIG. 18. A plurality of inner seals for sealing the liquid crystal inside plural cells formed on the first substrate W1 and an outer seal which surrounds the inner seals are applied on the top surface (bonding surface) of the first substrate W1, as has been discussed in the foregoing description referring to FIG. 10.

As shown in FIG. 18A, the pressure plate 141 and the table 142 chuck and hold the second substrate W2 and the first substrate W1, respectively. The vacuum process chamber 140 is evacuated, alignment marks are optically detected, and then the peripheral portions of the substrates W1 and W2 are aligned in a non-contact manner.

As shown in FIG. 18B, the peripheral pressing portion 141b is moved downward to press the peripheral portion of the second substrate W2 at a pressing load Fo. The pressing load Fo corresponds to a load when the second substrate W2 is in tight contact with the outer seal of the first substrate W1. In that situation, both substrates W1 and W2 are aligned with each other by using a camera C1. Ultraviolet rays are irradiated from the ultraviolet-ray irradiating device 149 to cure the outer seal, thereby temporarily fixing the peripheral portions of both substrates W1 and W2.

As shown in FIG. 18C, when the peripheral pressing portion 141b is unchucked, the peripheral pressing portion 141b is moved upward. Then, the central pressing portion 141a is moved downward. The center portion of the second substrate W2 is pressed at a pressing load Fc while positioning the center portions of the substrates W1 and W2 using a camera C2. The pressing load Fc corresponds to a load when the second substrate W2 is in tight contact with the inner seals. Thereafter, ultraviolet rays are irradiated from the ultraviolet-ray irradiating device 150 to cure the inner seals, thereby temporarily fixing the center portions of both substrates W1 and W2.

With the central pressing portion 141a unchucked, the central pressing portion 141a is moved upward. Then, the vacuum process chamber 140 is released. The substrates W1 and W2 are bonded to a predetermined cell gap (final substrate gap) by the atmospheric pressure.

After temporal fixing of the peripheral portions, the central pressing portion 141a may be moved downward, without lifting the peripheral pressing portion 141b up, for temporal fixing of the center portions.

The second embodiment has the following advantages in addition to those of the first embodiment.

(1) The pressure plate 141 comprises the central pressing portion 141a which presses the center portions of both substrates W1 and W2, and the peripheral pressing portion 141b which presses the peripheral portions of the substrates W1 and W2. The peripheral pressing portion 141b and the central pressing portion 141a are moved up and down independently of each other. As the peripheral portions and center portions of the substrates W1 and W2 can be pressed separately, bonding is carried out at the minimum load required. This can allow the substrates W1 and W2 to be bonded together at a predetermined cell gap while preventing the substrate W2 from sliding sideways and being misaligned with the substrate W1 by the reaction force generated at the time of bonding.

(2) In a case where a plurality of inner seals and an outer seal which surrounds the inner seals are provided, the peripheral portions of both substrates W1 and W2 are pressed after which the center portions of the substrates W1 and W2 are pressed. First, the outer seal is flattened to temporarily fix the peripheral portions of both substrates W1 and W2, and then the inner seals are flattened to temporarily fix the center portions thereof. This can further suppress the occurrence of positional deviation between the substrates W1 and W2.

(3) As the peripheral pressing portion 141b and the central pressing portion 141a are moved independently of each other, the press machine 121 is useful in adequately bonding large substrates W1 and W2.

It should be apparent to those skilled in the art that the present invention may be embodied in many other specific forms without departing from the spirit or scope of the invention. For example, the above embodiment may be modified as follows.

Each of the individual devices 12 to 14, 17 and 18 may be plural in quantity.

A vacuum process chamber 111 shown in FIG. 16 may be used in place of the separable vacuum process chamber 32. The vacuum process chamber 111 has a gate which is closed by a gate valve 112. The pressure plate 33a and the table 33b are provided in the vacuum process chamber 111 and the pressure plate 33a is suspended from the second support plate 26 via the suspension rods 34. The table 33b is supported on the positioning stage 36 via the legs 37. The upper bellows 35 provided around the associated suspension rod 34 connect the vacuum process chamber 111 to a support plate 113. The vacuum process chamber 111 is airtightly communicated with the upper bellows 35. The lower bellows 38 provided around the associated legs 37 connects the bottom of the vacuum process chamber 111 to the positioning stage 36. A pressing means 114 includes the pressure motor 27 which presses the pressure plate 33a. The base plate 21 is connected to the gate 22 similar to the one shown in FIG. 2, though not illustrated in FIG. 16. This modificaton has advantages similar to those of the above embodiment.

In a case where the lower container 32b can be supported by the lower bellows 38 alone, the support rods 39 shown in FIG. 2 may be omitted.

While the gate 22 is directly coupled to the base plate 21, another structure which has a sufficiently high rigidity may be provided between the base plate 21 and the gate 22.

The detection of the pressing load on the substrates W1 and W2 is not limited to the calculation from the amount of decrease from the sum of the weight A and the load B, but may be detected by other techniques as well.

The number of the load cells 31 is not limited to four.

The number of the CCD cameras 50 is not limited to four, but may be greater than four or may be in a range of one to three. To efficiently and accurately detect the pressing load and parallelism of the pressure plate 33a and the table 33b, it is preferable that the CCD cameras 50 should be four in quantity.

The pressing load may be detected and controlled without using all of the load cells 31, the linear scales 43a and 43b and the CCD cameras 50 but using only some of the components. In case of monitoring the loads detected by the four load cells 31 and the degree of flattening of the seal 55, an abnormality in the pressing load is detected with high precision and high reliability even if a mechanical deviation occurs in the press machine 17.

The degree of flattening of the seal 55 may be monitored by transparent type sensors instead of the CCD cameras 50. It is however preferable to use the CCD cameras 50 because a worker can visually check the image of the seal 55 on the monitor screen.

In the second embodiment, the central pressing portion 141a may be moved downward to press the center portions of both substrates W1 and W2 first, followed by unchucking of the central pressing portion 141a after which the peripheral pressing portion 141b may be moved downward to press the peripheral portions.

In the second embodiment, the central pressing portion 141a and the peripheral pressing portion 141b may be moved downward at a time to press the substrates W1 and W2 if pressing the entire surfaces does not cause sideway sliding of the substrate W2. That is, pressing by the central pressing portion 141a and the peripheral pressing portion 141b is controlled in accordance with the sizes of the substrates W1 and W2.

The present embodiment and examples are to be considered as illustrative and not restrictive and the invention is not to be limited to the details given herein, but may be modified within the scope and equivalence of the appended claims.

What is claimed is:

1. A method of fabricating a bonded substrate from first and second substrates, comprising:
forming a frame of a seal on a surface of the first substrate;
disposing the first and second substrates into a process chamber;
depressurizing the process chamber;
moving at least one of the first and second substrates in such a way that the first and second substrates approach each other,
computing a pressing load acting on the first and second substrates;
stopping movement of the at least one of the first and second substrates when the computed pressing load reaches a target load; and
setting a pressure in the process chamber back to atmospheric pressure.

2. The method according to claim 1, further comprising:
temporarily stopping movement of the at least one of the first and second substrates when the computed pressing load reaches a load lower than the target load; and
checking a difference between the predetermined load and the computed pressing load after said temporarily stopping movement.

3. The method according to claim 2, further comprising picking up an image of the seal and monitoring a degree of flattening of the seal after said checking a difference.

4. The method according to claim 2, further comprising picking up an image of the seal and monitoring a degree of flattening of the seal after said stopping movement of the at least one of the first and second substrates, and wherein when the degree of flattening of the seal lies within a predetermined range, pressing of the first and second substrates is stopped and said setting the pressure in the process chamber back to atmospheric pressure is carried out.

5. The method according to claim 1, wherein said computing the pressing load includes computation of a difference between two of a plurality of measured values from a plurality of load cells, and the method further includes removing the pressing load acting on the first and second substrates when the difference is equal to or greater than a predetermined value.

6. The method according to claim 1, further comprising:
dropping a liquid crystal in the frame of the seal; and
temporarily stopping movement of the at least one of the first and second substrates and bonding the first and second substrates when one of the first and second substrates contacts the seal and the pressing load reaches a load at which both of the first and second substrates contact the liquid crystal.

7. The method according to claim 1, wherein said disposing the first and second substrates in the process chamber includes holding the first and second substrates respectively with first and second holding plates provided in the process chamber, and the method further comprises:
detecting a distance between the first and second holding plates; and
stopping movement of the at least one of the first and second substrates when the distance reaches a target distance corresponding to a distance between the first and second substrates at a time when nearly the entire frame of the seal contacts the first and second substrates.

8. The method according to claim 1, wherein the target load is lower than a load caused by atmospheric pressure.

9. The method according to claim 8, wherein said setting the pressure in the process chamber back to atmospheric pressure includes compressing a gap between the first and second substrates to a predetermined value by using atmospheric pressure.

10. The method according to claim 1, wherein the target load is equivalent to a load when nearly the entire frame of the seal contacts the first and second substrates
